(19) United States
(12) Patent Application Publication
(10) Pub. No.: US 2017/0240125 A1
(43) Pub. Date: Aug. 24, 2017

(54) SYSTEM FOR COMMUNICATING BETWEEN VEHICLE AND TRAILER AND METHOD OF USING THE SAME

(71) Applicant: GM GLOBAL TECHNOLOGY OPERATIONS LLC, Detroit, MI (US)

(72) Inventors: Norman J. Weigert, Whitby (CA); Grant L. Meade, Whitby (CA); Vyacheslav Berezin, Newmarket (CA)

(21) Appl. No.: 15/048,167

(22) Filed: Feb. 19, 2016

(51) Int. Cl. B60R 16/023; B60Q 1/34; B60Q 1/44; H04B 3/56; H04L 27/00

(52) U.S. Cl. CPC B60R 16/023; H04B 3/56; H04L 27/0002; B60Q 1/44; B60Q 1/34

(57) ABSTRACT

A method and system for communication between a vehicle and trailer over existing power lines, such as by using a power line communication (PLC) arrangement. A PLC modem may convey data over electrical power that is supplied on the power lines and/or may elicit data from electrical power supplied on the power lines. This enables one or more electronic control units (ECUs) on the vehicle to communicate with input/output devices on the trailer, such as rearward-facing cameras or braking devices, without having to provide separate, dedicated communication lines therebetween.

### FIELD

The present invention relates generally to communications between vehicles and trailers and, more specifically, to communications conveyed over electrical power lines connected between vehicles and trailers.

### BACKGROUND

Many vehicles can come equipped with some type of towing package, which typically includes a trailer hitch and a trailer connector. The trailer connector provides electrical power from the vehicle to the trailer and powers electrical components on the trailer, such as tail lights and/or electric braking devices. Most trailers have minimal wiring that is configured to power these types of electrical components, but do not have separate data connections designed to exchange information between the vehicle and the trailer. Wireless connections could be used to connect devices on a trailer to those on a vehicle, however, wireless connections can be susceptible to interference and other undesirable effects.

Therefore, there is a need for reliable and cost effective communications between vehicles and the trailers that they tow, particularly in view of all of the cameras and other sensors now being employed on vehicles.

### SUMMARY

According to one embodiment, there is provided a system for use with a vehicle and a trailer, comprising: an electrical component mounted on the trailer; a communication module mounted on the trailer that includes an input/output device coupled to a modem; a power line mounted on the trailer that is coupled to the electrical component and the modem; and a vehicle-trailer interface mounted on the trailer that is coupled to the power line and is arranged to connect with a corresponding interface mounted on the vehicle, wherein the system is configured such that the power line both provides electrical power to the electrical component and conveys data for the modem.

According to another embodiment, there is provided a system for use with a vehicle and a trailer, comprising: a modem mounted on the vehicle; an electronic control unit (ECU) that is mounted on the vehicle and that is configured to provide data to the modem; a power line mounted on the vehicle that is coupled to the modem; and a vehicle-trailer interface mounted on the vehicle that is coupled to the power line and is arranged to connect with a corresponding interface mounted on the trailer, wherein the system is configured such that the power line both provides electrical power to the trailer and conveys data for the modem.

According to another embodiment, there is provided a method of communicating data between a vehicle and a trailer, comprising the steps of: exchanging data between an electronic control unit (ECU) and a modem, wherein the ECU and the modem are mounted on the vehicle; transferring electrical power between the modem and a vehicle-trailer interface via a power line, wherein the vehicle-trailer interface and the power line are mounted on the vehicle; and exchanging data between the modem and the vehicle-trailer interface via the power line at the same time the electrical power is transferring between the modem and the vehicle-trailer interface, wherein the exchanging data includes at least one of a data transmission or a data reception; when the exchanging data includes a data transmission, data is transmitted from the modem to the vehicle-trailer interface and includes control signals configured to control one or more output devices mounted on the trailer; and when the exchanging data includes a data reception, data is received from the vehicle-trailer interface at the modem and includes video signals or sensor signals from one or more input devices mounted on the trailer.

### DRAWINGS

Preferred exemplary embodiments will hereinafter be described in conjunction with the appended drawings, wherein like designations denote like elements, and wherein:

FIG. 1 is a block diagram depicting an example of systems that may be used with a vehicle and a trailer;

FIG. 2 is a rear view of a trailer with an embodiment of a module that may be used with the systems of FIG. 1;

FIGS. 3 and 4 are top views of a vehicle and a trailer, where the trailer in FIG. 4 is experiencing trailer sway; and

FIGS. 5 and 6 are flowcharts illustrating embodiments of communication methods that may be used with the systems of FIG. 1, where the method in FIG. 5 includes communications from the vehicle to the trailer and the method in FIG. 6 includes communications from the trailer to the vehicle

### DESCRIPTION

The systems and method described herein are generally designed to provide for communication between a vehicle and a trailer over existing power lines and connections. In one embodiment, a system is arranged so that video output from a rear-facing camera mounted at the end of the trailer is provided to a visual display inside of the vehicle, and is done so over the same power lines that are used for electrical devices like trailer tail lights. This enables a driver to “see” behind the trailer, without having to add dedicated communication lines connecting the camera to the visual display. In a different embodiment, an electronic control unit (ECU) in the vehicle sends braking control signals over existing power lines to one or more braking devices on the trailer in order to control trailer stability issues, such as trailer sway. In this way, powerful ECUs that are already present in the vehicle can be used to control certain aspects of trailer operation without having to provide dedicated communication lines therebetween. In each of these embodiments, the system may include a power line communication (PLC) modem that modulates and/or demodulates data so that it can be communicated over standard DC power lines that already exist in most vehicles and trailers. The aforementioned embodiments are only some of the examples of how the system may be used, as others certainly exist.

As used herein, an input/output device is any device, component, or module in the system that can either provide data or receive data and operate according to information contained therein. For example, a component may be considered an input device when it gathers data that is then conveyed to an ECU (e.g., a trailer-mounted camera that captures video data that is then conveyed to a vehicle-mounted ECU). Alternatively, a device may also be considered an output device when it receives data that was conveyed to it from an ECU (e.g., a trailer-mounted braking device that receives and operates according to brake control signals from a vehicle-mounted ECU). In the preceding examples, the terms “input” and “output” were from the perspective of an ECU, typically a vehicle-mounted ECU. It should be noted that an input/output device may be part of a communication module, which also includes a modem and can be used to receive data from and/or send data to one or more other devices, modules, components and/or communication modules located on the vehicle or the trailer.

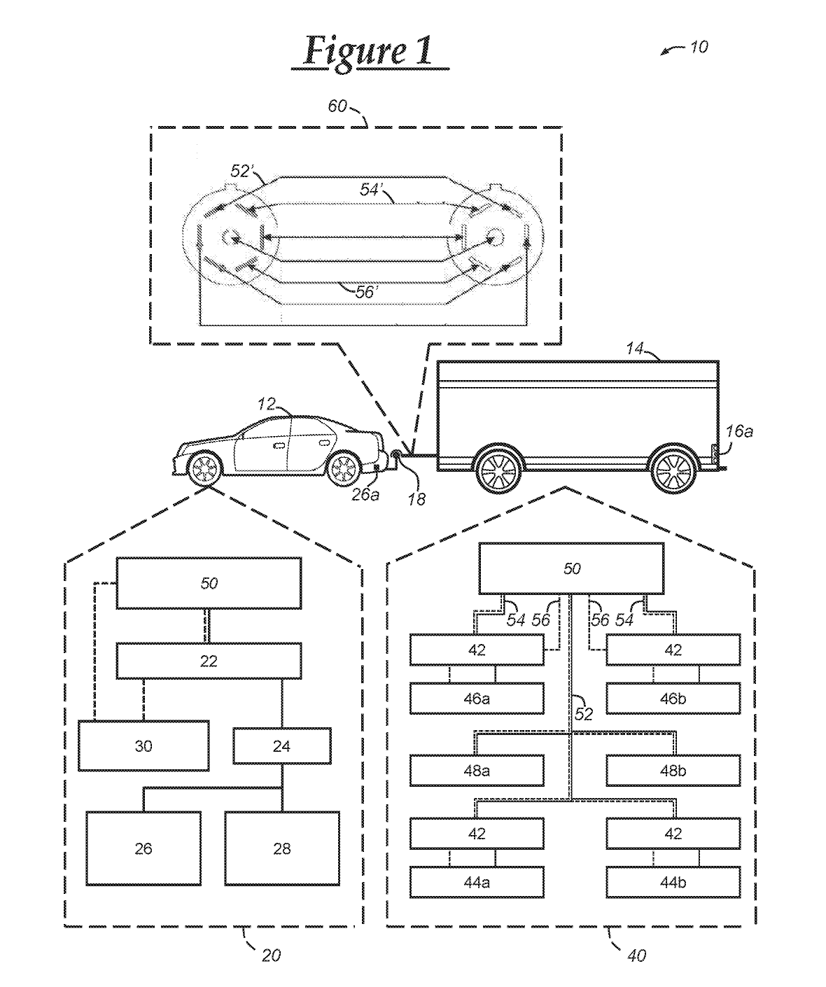

Referring now to the drawings, FIG. 1 depicts a potential embodiment of a system 10 for use with a vehicle and a trailer. System 10 includes a vehicle 12, trailer 14, and one or more vehicle-trailer interfaces 50. The vehicle and trailer are electrically coupled to one another via the vehicle-trailer interfaces 50, and are structurally or mechanically coupled to another via trailer hitch 18. The vehicle includes vehicle hardware 20 and the trailer includes trailer hardware 40.

For purposes of clarity with respect to the embodiment shown in FIG. 1, the dashed lines in vehicle hardware 20 and trailer hardware 40 are intended to illustrate the transfer of electrical power whereas the solid lines in vehicle hardware 20 and trailer hardware 40 are meant to illustrate the conveyance of data. A solid line that is directly adjacent to a dashed line (e.g., the line connecting PLC modem 22 and vehicle-trailer interface 50 in vehicle hardware 20) illustrates a power line where both data and power can be conveyed (e.g., according to a power line communication (PLC) protocol) and does not represent separate power and data lines, as will be further detailed below. All other connecting lines, such as those in vehicle connection 60, are used to illustrate any sort of physical or electrical connection.

Vehicle 12 is depicted as a passenger car, but it should be appreciated that the present method and system may be implemented with other vehicles including motorcycles, trucks (including semi-trucks), sports utility vehicles (SUVs), recreational vehicles (RVs), marine vessels, aircrafts, trains, etc. Some components of vehicle hardware 20 that are more relevant to the present systems and method are shown in FIG. 1, although skilled artisans will appreciate that a much more extensive collection of vehicle hardware exists in most modern vehicles. The vehicle hardware 20 may include power line communication (PLC) modem 22, an electronic control unit (ECU) 24, trailer sway detector 26, visual display 28, a power source 30, and a first vehicle-trailer interface 50. It should also be appreciated that the vehicle hardware 20 shown in FIG. 1 is only for purposes of illustration, as the actual arrangement or configuration of components, devices, modules and/or systems could vary substantially from that shown here and it is not limited to any particular embodiment. For instance, PLC modem 22, ECU 24, trailer sway detector 26, power source 30, and visual display 28 may be stand-alone items (as shown) or they may be combined or integrated with other components, devices, modules and/or systems in the vehicle. Put differently, the particular architecture of system 10 is not critical, as the system could be provided according to myriad configurations and arrangements.

Electronic control unit (ECU) 24 is a vehicle module that is capable of communicating with one or more electronic components or devices, such as trailer sway detector 26, visual display 28, or PLC modem 22. ECU 24 may include a processing device and a memory device. Additionally, ECU 24 may include any variety of electronic processing devices, memory devices, input/output (I/O) devices, and/or other known components, and may perform various processing, control and/or communication related functions. According to one embodiment, the ECU 24 is configured to provide data to trailer sway detector 26 and to receive trailer sway data from the trailer sway detector. Here, the ECU may use its processing unit to process the trailer sway data and to generate brake control signals that may be sent to braking devices mounted on trailer 14. In addition, or alternatively, the ECU can receive data from PLC modem 22 and, in the case where the data received is video data, the ECU may communicate the video data to visual display 28, which may display the video data for a vehicle operator to see. This may be specifically useful when the vehicle operator is operating the vehicle in a backward motion and desires to see what is behind the trailer. It is worth noting that ECU 24 can be integrated or combined with other components, devices, modules and/or systems in the vehicle, such as PLC modem 22, visual display 28, trailer sway detector 26, a body control module, an infotainment module and/or a telematics unit, to cite several examples. It is also possible for PLC modem 22 to receive and/or provide data directly to other components, devices, modules and/or systems in the vehicle without going through the ECU 24.

Power source 30 may be a vehicle battery that provides direct current (DC) power to one or more vehicle devices, components, or modules. Here, for example, the vehicle battery may provide voltage in the range of 10V to 40V, such as are included in many passenger land vehicles. In another embodiment, power source 30 may be a primary propulsion battery used in an electric vehicle (EV), a hybrid electric vehicle (HEV), or any derivative thereof. In any event, the power source is coupled to a modem, such as modem 22, which may in turn provide electrical power to a trailer via vehicle-trailer interface(s).

Modems 22 and 42 are used to send data over power lines between the vehicle and the trailer. The modems are shown as power line communication (PLC) modems, however, one should appreciate that these modems may be any device that can convey data over electrical power and/or elicit data from the electrical power. For example, any of the protocols of IEEE 1901 may be used by the modems to convey data over electrical power. The PLC modems may receive an input power, such as from power source 30, and data from a data line, such as from ECU 24. The PLC modems may be configured to convey the data over a power line such that the data is communicated over the power line. In one embodiment, PLC modem 22 modulates (such as through frequency or amplitude modulation) the data received from ECU 24 over the electrical power supplied by power source 30 thereby resulting in a modulated electrical power output as illustrated by the adjacent dashed and solid lines between vehicle-interface 50 and PLC modem 22. Here, power source 30 may be a vehicle battery that provides direct-current (DC) electrical power.

In yet another embodiment, PLC modem 42 is configured to receive a modulated electrical power output, such as one generated by PLC modem 22, and then demodulate the modulated electrical power output as to obtain the data that was modulated thereon. The PLC modem may then provide the data to an input/output device, such as camera 44a, and the electrical power to an electrical component, such as tail light 48a. As shown, PLC modem may be coupled to multiple power/data lines. In the case of the PLC modems that are coupled to brakes 46, there is an additional power line 56 such that more power may be provided thereto. This is especially useful when the electrical power line is rated for less amperage than the device to which it is coupled requires.

In any event, the modems may communicate in a unidirectional or directional manner. In the case of communications in a bidirectional manner, the data may be modulated over a single power line connection (e.g., a power line that runs from a first terminal of the battery to a first terminal of an electrical component or modem) according to a predetermined protocol. For example, the predetermined protocol may incorporate the use of a clock where each PLC modem (e.g., PLC modem 22 and PLC modem 42) modulates and/or demodulates data over the electrical power according to the clock. Put differently, PLC modem 42 may modulate electrical power according to data it wishes to communicate to PLC modem 22 during even clock cycles (e.g., when the nanosecond least-significant digit is even) and PLC modem 22 may modulate electrical power according to data it wishes to communicate to PLC modem 42 during odd clock cycles (e.g., when the nanosecond least-significant digit is odd). Accordingly, PLC modem 22 may demodulate data conveyed over the power line during even clock cycles and PLC modem 42 may demodulate data conveyed over the power line during odd clock cycles. Another embodiment of bi-directional communications between modems may be implemented wherein the predetermined protocol includes each modem modulating data to be communicated out by it on a different channel (e.g., a different frequency channel).

According to another embodiment of bi-directional communications, the modems may operate to modulate distinct power lines. For example, a power line that contains a source portion that runs from a first terminal of the battery to a first terminal of an electrical component or modem and the sinking portion of the power line may be connected between a second terminal of the battery and a second terminal of an electrical component or modem. Here, for example, PLC modem 22 may modulate data over the source portion of the power line (e.g., the line running from the first terminal of the source to the first terminal of the component or modem) and PLC modem 42 may demodulate this same portion of the line as to obtain the communications conveyed thereover. Likewise, PLC modem 42 may modulate data over the sinking portion of the power line (e.g., the line running from the first terminal of the source to the first terminal of the component or modem) and PLC modem 22 may demodulate this same portion of the line as to obtain the communications conveyed thereover.

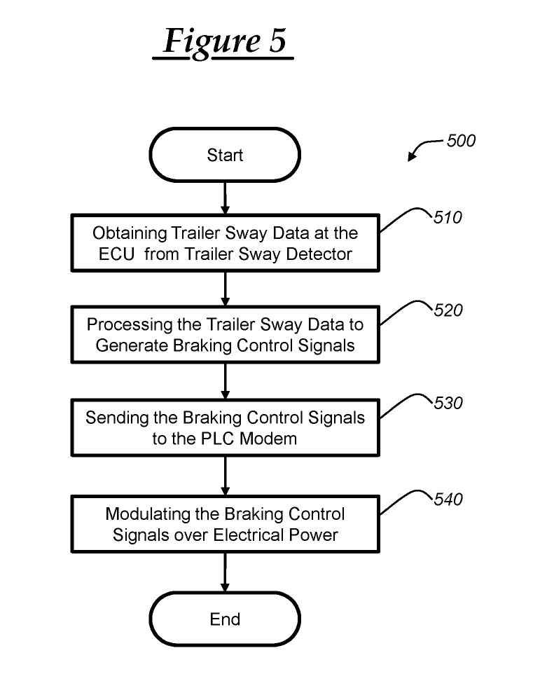

Referring now to FIG. 3 and FIG. 4, there is shown a top view of the system 10. As shown, vehicle 12 includes trailer sway detectors 26a and 26b. Each trailer sway detector is mounted on the anterior portion of vehicle 12 such that it faces the trailer and includes a sensor for sensing the sway of trailer 14. The sensor may be a camera, a radar sensor, a laser sensor, or a lidar sensor, for example. The sensors may individually or cooperatively operate to provide trailer sway information. Trailer sway may occur when the vehicle and trailer are proceeding down a road on a windy day, when they are traveling at high speeds, or when a combination of these factors is present. If a trailer sways too much it may cause the vehicle to lose control thereby damaging the vehicle and/or the vehicle occupants. There are myriad preventive measures to mitigate the effects of trailer sway, one such measure being to individually control the braking devices on the trailer. For example, referring specifically now to FIG. 4, if the trailer sways to vehicle 12's right side, applying the trailer's right brake will cause trailer 14 to straighten out, as seen in FIG. 3. To implement such an embodiment, trailer sway detectors 26 may sense the distance between the rear of vehicle 12 and the front of trailer 14 and then provide this information to ECU 24. ECU 24 may then process this data (e.g., comparing the sensed distances to see which one is less thereby indicating a sway to that side) and therefrom can generate braking control signals that may be sent via PLC modem 22 to braking devices in trailer 14, such as right brake 46b.

Referring back to FIG. 1, trailer 14 is depicted as a storage trailer, but it should be appreciated that the present systems and method may be implemented with other trailers including boat trailers, livestock trailers, semi-trailers, motorcycle trailers, popup camper trailers, pusher trailers, travel trailers, etc. Some components of trailer hardware 40 that are more relevant to the present systems and method are shown in FIG. 1, although skilled artisans will appreciate that a much more extensive collection of trailer hardware exists in modern trailers. The trailer 14 may include one or more PLC modems 42, one or more braking devices 46, one or more tail lights 48, and one or more cameras 44. It should also be appreciated that the trailer hardware 40 shown in FIG. 1 is only for purposes of illustration, as the actual arrangement or configuration of components, devices, modules and/or systems could vary substantially from that shown here and it is not limited to any particular embodiment. For instance, PLC modems 42, braking devices 46, tail lights 48, and cameras 44 may be stand-alone items or they may be combined or integrated with other components, devices, modules and/or systems in the vehicle. Put differently, the particular architecture of system 10 is not critical, as the system could be provided according to myriad configurations and arrangements. In another embodiment, a second trailer may be attached to trailer 14 via an interface similar to the vehicle-trailer interface such that the vehicle may communicate with the second trailer via power line communications that pass through trailer 14. Additional trailers may be attached and communicated with by the vehicle or other trailers in a like arrangement.

Brakes 46 are mounted to trailer 14 and are output devices. Brakes 46 included in trailer hardware 40 may be any type of braking device that can inhibit the velocity and/or wheel rotation of trailer 14. As shown in the embodiment in FIG. 1, there are only two braking devices, left brake 46a and right brake 46b; however, there may be one or more braking devices, such as a braking device for each wheel included in trailer 14. One or more braking devices may be included in a communication module which also includes a modem, such as PLC modem 42. For example, the PLC modem 42 that is directly coupled to left brake 46a and left brake 46a may be included in a single communication module. As used herein, a communication module is any module that contains a modem and an input/output device that is coupled to a modem.

In one embodiment, brakes 46 are electric braking devices that are powered by power source 30 via vehicle-trailer interfaces 50. Furthermore, brakes 46 each include a braking mechanism which is a hardware component that, upon actuation, may engage a wheel thereby restricting its rotation. Brakes 46 may also include a brake driver that may engage the braking mechanism upon receiving a braking control signal provided from ECU 24 via the PLC modems and vehicle-trailer interfaces coupled therebetween. In another embodiment, brakes 46 may include a trailer brake control unit, a trailer suspension control unit, or a trailer stability control unit.

Cameras 44 are input devices that are mounted on trailer 14. Cameras 44 can be used to capture photographs, videos, and/or other information pertaining to light. Cameras 44 may each include a memory device and a processing device to store and/or process data that it captures or otherwise obtains. Cameras 44 may be included with a PLC modem 42 as part of a communication module. As shown in the illustrated embodiment, there are two cameras, one left camera 44a and one right camera 44b. The data obtained by the two cameras may be sent to ECU 24 of the vehicle and then combined and processed therein. The use of the two cameras in a stereoscopic orientation, such as, for example, as shown in FIG. 1, provides video data from multiple perspectives of an area and, when combined and processed according to a three-dimensional rendering algorithm, a three-dimensional reconstruction of the area (e.g., the area behind the trailer) may be rendered. This rendering may then be displayed on a visual display, such as visual display 28. A stereoscopic orientation refers to an orientation of multiple cameras such that their fields of view overlap thereby allowing multiple perspectives of the area to which their respective fields of view overlap.

Each camera is included as part of a communication module and is coupled to a PLC modem 42 which is also included therein. The cameras may capture video data from the anterior portion of trailer 14 and then PLC modem may modulate the video data over power line 52 such that ECU 24 receives the data via vehicle-trailer interface 50 and PLC modem 22. Accordingly, ECU 24 may process and/or send the video data to visual display 28, which may display the data for one or more vehicle operators to view.

Tail lights 48 are electrical components that are mounted to trailer 14. As used herein, an electrical component is any component, device, or module that uses electricity to power its operation(s). Tail lights 48 may include at least one light-emitting component, such as an LED or incandescent light bulb, and are powered by power source 30 via the electrical power connection provided therebetween. For example, tail lights 48 may be a brake light, a running light, a turn signal light, or a reverse light. As shown, the same power line (power line 52) is coupled to vehicle trailer interface 50 and PLC modems 42. This power line may carry a modulated electrical power output such that electrical power may be provided to tail lights 48 and data provided to cameras 44.

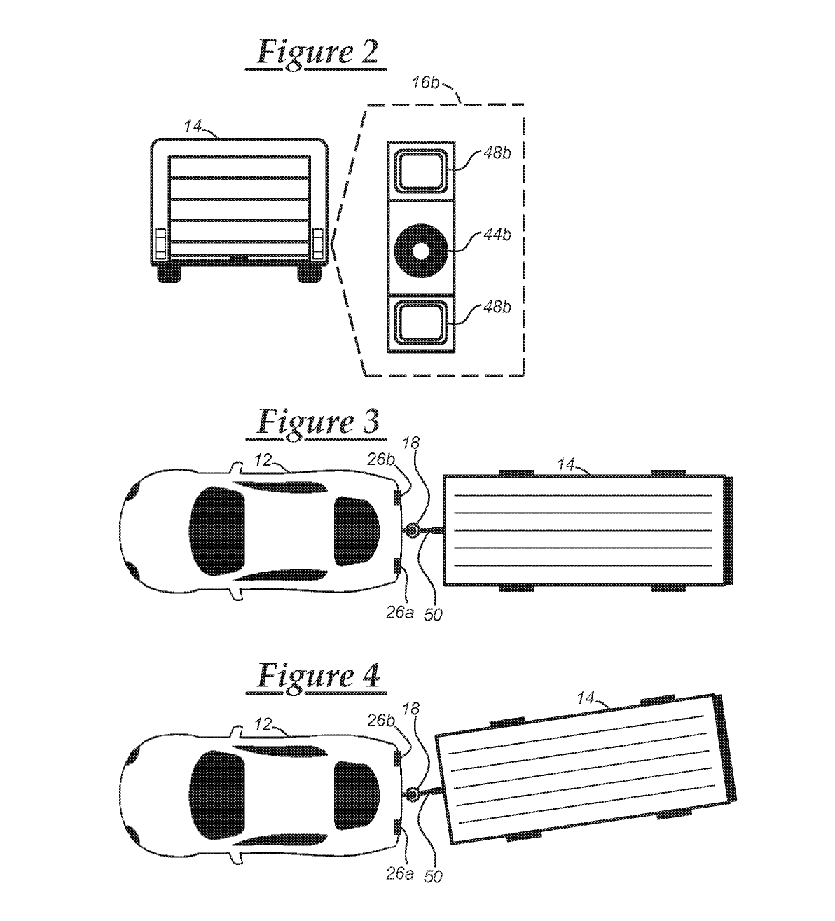

Referring now to FIG. 2, there is shown part of an embodiment of a system for use with a vehicle and a trailer. Specifically, there is shown the rear-end of trailer 14 that includes module 16b. Module 16b contains rear-facing camera 44b and tail lights 48b. Module 16b may be installed by the OEM of trailer 14 or may be installed as an aftermarket component. In the latter case, the original tail light enclosure module may be removed and module 16b installed in its place. Module 16b may include input/output devices, such as camera 44b, wherein these input/output devices may communicate with the vehicle via the conveying and eliciting of data over the electrical power line to which the previous tail light enclosure module used and which the current tail lights 48 may use as a means of receiving power.

In some embodiments, the tail lights may also be controlled by the ECU of the vehicle. For example, tail lights 48 may be directed to emit light such that the camera(s) may obtain a better image. This may be accomplished by sending power to the tail lights when it is desired that they emit light. Or, this may be achieved by sending control signals over the power line(s) and then using a controller at the trailer to then control operation of the tail lights. In some cases, this may be useful during the nighttime and/or when the sun is directly behind the trailer thereby creating a blooming effect around objects which are behind the vehicle. In any case, the operation of the tail lights may be synced in or out of phase with the cameras which may mitigate potential blooming effects and/or other lighting problems that may arise. Here, when the tail lights are operated to emit light in or out of sync with the camera(s), in some embodiments it is not necessary that control signals be sent from the vehicle to control the tail lights. For example, the tail lights may be controlled by a controller on the trailer that may also be coupled to the camera(s). The controller may operate the tail lights to emit light according to the camera's frame rate, which it may realize through initial programming or through obtaining data from the camera or another device.

Referring back to FIG. 1, vehicle 12 and trailer 14 include complimentary vehicle-trailer interfaces 50. Vehicle-trailer interfaces 50 are illustrated as a standard 7-pin SAE 560 compliant interface; however, it should be appreciated that vehicle-trailer interfaces 50 may be implemented as any type of electrical connection such that electric power may flow between vehicle 12 and trailer 14. Vehicle-trailer interface connection 60 includes two interfaces 50 such that they fit together to in a complementary fashion. In one embodiment, first vehicle-trailer interface 50 which is included in vehicle hardware 20 includes one or more female and/or male pins. Accordingly, second vehicle-trailer interface 50 which is included in trailer hardware 40 includes complimentary male and/or female pins such that they complement first vehicle-trailer interface 50 pins. For purposes of illustration, vehicle-trailer interface connection 60 is depicted to provide a clear illustration of an embodiment of the connections between vehicle-trailer interfaces 50. Numerals 52′, 54′, and 56′ shown in vehicle-trailer interface connection 60 are provided to each illustrate an electrical path through the connection and are included for purposes of facilitating the explanation provided herein. Power lines 52, 54, and 56 in trailer hardware are wires that are capable of carrying electrical power and correspond to individual connections 52′, 54′, and 56′, as shown in connection 60.

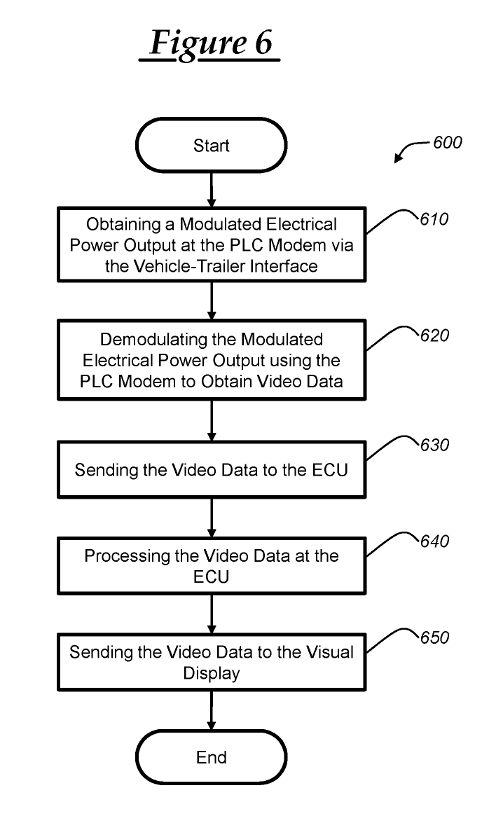

Referring now to FIGS. 5 and 6, there is provided a couple embodiments of a method of communicating data between a vehicle and a trailer. The method may be carried out at a vehicle and generally includes the steps of obtaining or generating data at an ECU, communicating the data between the ECU and a modem, transferring electrical power between the modem and a vehicle-trailer interface via a power line, and conveying data over the electrical power that is to be supplied to the vehicle-trailer interface or obtaining data from the electrical power that is transferred between the modem and the vehicle-trailer interface.

Referring specifically to FIG. 5, there is provided an embodiment of a method of communicating data between a vehicle and a trailer, wherein the embodiment shows a method 500 that can be used to control braking devices on a trailer according to data obtained at the vehicle via a trailer sway detector. This embodiment allows a vehicle to send data to braking devices as to control individual braking devices, as opposed to merely controlling the amount of amperage all braking devices receive. For example, without such a method and/or system, the vehicle can only control the braking devices on the trailer by sending electrical power through the vehicle-trailer interface. Many standard trailer systems use a vehicle-trailer interface that only has one power line for all the brakes of the trailer and no data lines. This embodiment allows conveying individual brake control data (e.g., brake control signals) over existing standard vehicle-trailer interfaces as to provide a greater range of control and scalability with respect to trailer brake systems, and can even control individual braking devices independently of the towing vehicle 12.

To begin method 500, trailer sway data is obtained at an ECU that is mounted on the vehicle from a trailer sway detector, as shown in step 510. Firstly, the trailer sway data is collected by one or more trailer sway detectors 26. For example, trailer sway detectors 26a and 26b may use sensors included therein to measure the distance between the rear of vehicle 12 and the front left and right side of trailer 14, respectively. Upon capturing trailer sway data (e.g., the sensed distances), the trailer sway detectors may send this data to ECU 24. Alternatively, the trailer sway detectors may send the trailer sway data to an intermediate device that can combine and process the data. In any event, the trailer sway data is sent to ECU 24.

Next, in step 520, the trailer sway data is processed by the ECU to generate braking control signals. A brake control signal is data that may be used to control actuation of a braking device, such as left brake 46a on trailer 14. To generate one or more brake control signals, the ECU processes the trailer sway data, as well as other data that may be useful for determining which braking device should be actuated and to what degree. A trailer sway control algorithm can be used that takes as input the trailer sway data (e.g., the distances obtained by detectors 26) and velocity of vehicle 12. Such an algorithm may compare the distances and, upon the determination that the distance measured by detector 26b is less and to what extent the difference is, the ECU can then generate a LBL (left brake level) and RBL (right brake level), each which may be expressed in terms of percentage of the total braking device power. The pair of values may be combined with other data, such as metadata or other control data. In the case that the trailer is swaying to the right, as shown in FIG. 4, the generated brake control signal may be, for example, (LBL: 20%, RBL: 70%).

After brake control signals are generated, the method continues to step 530. At this step, data (e.g., brake control signals) is communicated between the ECU and a PLC modem, such as PLC modem 22. The data may be sent via a direct wired connection between ECU 24 and PLC modem 22 or, alternatively, may be sent according to a wireless protocol, such as those using an IEEE 802.11 wireless protocol. In another embodiment, the data may be communicated via a vehicle communications bus to which ECU 24 and PLC modem 22 are coupled to. In any event, the data is received by the PLC modem.

After step 530, the braking control signal(s) are conveyed over electrical power that is provided to the PLC modem. As shown in the illustrated embodiment of FIG. 1, PLC modem 22 is electrically coupled to power source 30 and receives electrical power therefrom. The power source, as indicated above, may be a DC power supply or an AC power supply. In many embodiments, the power supply will be a vehicle battery that provides DC current with, for example, voltage ranging from 10V to 40V. In any event, the PLC modem may operate to modulate the data it received (e.g., the braking control signals) over the electric power it receives. PLC modem 22 may carry this out through use of frequency modulation and/or amplitude modulation wherein the electrical voltage is modulated as to convey the data. In another embodiment, the modem may convey the data over the electrical power using any one or more of the protocols of IEEE 1901 or similar power line communication protocol. The electric power with data modulated or otherwise conveyed over it is referred herein as a modulated electric power output. After the data is modulated, the method continues to step 540.

After step 540, the modulated electric power output is transferred from the modem to the vehicle-trailer interface via a power line. As shown in the illustrated embodiment in FIG. 1, the connection between PLC modem 22 and vehicle-trailer interface 50 (shown as a dashed line (representing the power) and a solid line (representing the data)) represents a power line. It should be appreciated that even though this power line is illustrated in FIG. 1 as two lines (a dashed and a solid line) the power line merely consists of a single electrical wire capable of carrying electrical power. One should note that the modulated electrical power output may be received at PLC modem 42 via vehicle-trailer interfaces 50 and then demodulated by the receiving modem. The demodulated electrical power signal results in the data that was modulated by PLC modem 22, which, for example could be braking control signals. These signals may then be used by braking devices to actuate their respective braking mechanisms included therein to the degree indicated by the braking control signals. For example, upon receiving left brake 46a receiving the pair (LBL: 20%, RBL: 70%), the left brake will actuate its braking mechanism 20% of its full braking power; the right brake will do the same with respect to the right brake level (RBL).

Referring now to FIG. 6, there is provided an embodiment of a method of communicating data between a vehicle and a trailer, wherein the embodiment is illustrated as a method 600 that can be used to receive and display video data that was captured by a camera on a trailer. Method 600 allows the vehicle to receive the video data via the vehicle-trailer interface using power line communications whereby a PLC modem at the vehicle receives and then demodulates a modulated electrical power output to obtain the video data. This allows for a vehicle to capture video data from behind the trailer and display the video data for a vehicle operator to view when, for example, he is operating the vehicle in reverse (i.e., to “see” behind an otherwise obstructing trailer). Using a modem, such as a power line communication (PLC) modem, allows easy incorporation of such a system into existing trailer systems that may not otherwise have the hardware capabilities to achieve such a feat.

Method 600 begins with step 610, wherein a modulated electrical power output is obtained from the vehicle-trailer interface. More specifically, a modulated electrical power output is obtained at the PLC modem via the vehicle-trailer interface. Here, the modulated electrical power output contains video data that is modulated over electrical power. The video data may, for example, be captured by rear-facing cameras 44 mounted on the rear of the trailer and, then, for example, modulated over power line 52 by PLC modem 42 on the trailer whereby PLC modem 22 may obtain the modulated electrical power output.

Next, step 620 is carried out wherein data is obtained from the electrical power that is transferred between modem 22 and vehicle-trailer interface 50. PLC modem 22, through demodulation of the modulated electrical power output, obtains the video data that was captured by one or more cameras 44 on trailer 14. Demodulation may be performed through analysis of the electrical power voltage, amperage, etc.

In step 630, after the data is obtained via demodulation of the modulated electrical power output, the data is sent from the modem to the ECU. In one embodiment, the data may be sent via a direct wired connection between ECU 24 and PLC modem 22 or, alternatively, may be sent according to a wireless protocol, such as those using an IEEE 802.11 wireless protocol. In another embodiment, the data may be communicated via a vehicle communications bus to which ECU 24 and PLC modem 22 are coupled to. In any event, the data is obtained by ECU 24.

Next, in step 640, the ECU may process the video data through use of a processor included therein. ECU 24 may decode the obtained video data and/or may encode the video data according to a communications protocol that it may use to communicate with other vehicle electronics, such as PLC modem 22 and/or visual display 28. Additionally, the ECU may encode/decode the video data according to a codec used by visual display 28 and/or camera 44. In one embodiment, the ECU receives video data from both cameras 44. Thereafter, the ECU processes the video data according to a three-dimensional rendering algorithm to produce a three-dimensional reconstruction of the area behind the trailer. The three-dimensional rendering algorithm uses the video data from each camera, wherein each camera's video data provides a different perspective of the area to be reconstructed (e.g., the area directly behind the trailer). The algorithm may be any of those known in the art, such as those relating to image-based modeling and rendering (IBMR) and/or other algorithm that may combine or use the stereoscopic video data to produce a three-dimensional rendering or reconstruction.

After the ECU processes the data, the ECU sends the data to the visual display, as illustrated in step 650. The data may be communicated to visual display 28 from ECU 24 through a direct wired connection and/or may be communicated via using an IEEE 802.11 wireless protocol. In another embodiment, the data may be communicated to visual display 28 via a communications bus to which ECU 24 and visual display 28 are coupled to. In any event, the visual display will receive the video data and then may display the video data for a vehicle operator to view.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A system for use with a vehicle and a trailer, comprising:
a plurality of electrical components mounted on the trailer, wherein each of the electrical components is a tail lamp component;
a plurality of communication modules mounted on the trailer that each includes an input/output device coupled to a modem, wherein each of the input/output devices is a rear facing camera directed to an area directly behind the trailer, and wherein a field of view of each of the cameras overlaps to provide video data that can be combined at the vehicle to obtain three-dimensional information regarding the area behind the trailer;
a plurality of power lines mounted on the trailer that are each coupled to one of the electrical components and one of the modems; and
a vehicle-trailer interface mounted on the trailer that is coupled to the power lines and is arranged to connect with a corresponding interface mounted on the vehicle, wherein the system is configured such that the power lines both provide electrical power to the electrical components and convey the video data for the modems.

2. The system of claim 1, wherein the electrical component includes at least one tail lamp component that is provided electrical power by the power line and is selected from the group consisting of: a brake light, a running light, a turn signal light, or a reverse light.

3. The system of claim 1, wherein the input/output device includes at least one input device that gathers data for transmission over the power line and is selected from the group consisting of: a camera, a radar sensor, a laser sensor, or a lidar sensor.

4. The system of claim 1, wherein the electrical component is a tail lamp component and the input/output device is a rear facing camera, and the tail lamp component and the rear facing camera are integrated within a single module that is mounted on a rear end of the trailer.

5. The system of claim 1, wherein the input/output device includes at least one output device that receives data over the power line and is selected from the group consisting of: a trailer brake control unit, a trailer suspension control unit, or a trailer stability control unit.

6. The system of claim 1, wherein the modem is a power line communication (PLC) modem.

7. The system of claim 6, wherein the power line communication (PLC) modem is configured to modulate data from the input/output device for transmission over the power line to a vehicle electronic control unit (ECU), to demodulate data from the vehicle electronic control unit (ECU) received over power line, or to both modulate and demodulate data conveyed over the power line.

8. The system of claim 1, wherein the vehicle-trailer interface is a standard 7-pin trailer interface, and the data conveyed for the modem is conveyed over one or more of the 7 standard pins.

9. The system of claim 1, wherein the system further comprises a plurality of communication modules mounted on the trailer, each of which includes an input device in the form of a camera coupled to a modem, and the plurality of communication modules mounted on the trailer and an electronic control unit (ECU) mounted on the vehicle are part of a distributed stereo vision system.

10. A system for use with a vehicle and a trailer, comprising:
a modem mounted on the vehicle;
an electronic control unit (ECU) that is mounted on the vehicle and that is configured to provide data to the modem;
a power line mounted on the vehicle that is coupled to the modem;
a separate power line mounted on the vehicle that provides electrical power to the vehicle-trailer interface directly from a power source;
a vehicle-trailer interface mounted on the vehicle that is coupled to the power line and is arranged to connect with a corresponding interface mounted on the trailer, wherein the system is configured such that the power line both provides electrical power to one or more braking devices of the trailer and conveys trailer braking data for the modem, wherein the trailer braking data is data that can be used to control the one or more braking devices of the trailer, and wherein the separate power line provides supplemental electrical power to the one or more braking devices; and
a trailer sway detector, wherein the ECU is coupled to the trailer sway detector such that the trailer sway detector provides trailer sway data to the ECU and wherein the trailer braking data provided to the modem by the ECU is based at least partly on the trailer sway data.

11. The system of claim 10, wherein the modem is coupled to a vehicle battery and wherein the vehicle battery provides DC power to the modem.

12. The system of claim 10, wherein the modem is configured to obtain data that is conveyed over the power line and wherein the ECU is configured to receive the data from the modem.

13. The system of claim 12, wherein the data was gathered from at least one input/output device mounted on the trailer, wherein the at least one input/output device is configured to gather data for transmission to the vehicle and is selected from the group consisting of: a camera, a radar sensor, a laser sensor, or a lidar sensor.

14. The system of claim 13, wherein the data is video data that was collected by a rear-facing camera on the trailer and wherein the system further comprises a display that is coupled to the ECU and configured to display the video data.

15. (canceled)

16. The system of claim 10, wherein the modem is a power line communication (PLC) modem.

17. The system of claim 16, wherein the power line communication (PLC) modem is configured to modulate data from the ECU for transmission over the power line to at least one input/output device mounted on the trailer, to demodulate data from the at least one input/output device received over power line, or to both modulate and demodulate data conveyed over the power line.

18. The system of claim 10, wherein the vehicle-trailer interface is a standard 7-pin trailer interface, and the data conveyed for the modem is conveyed over one or more of the 7 standard pins.

19. A method of communicating data between a vehicle and a trailer, comprising the steps of:
exchanging data between an electronic control unit (ECU) and a modem, wherein the ECU and the modem are mounted on the vehicle;
transferring electrical power between the modem and a vehicle-trailer interface via a power line, wherein the vehicle-trailer interface and the power line are mounted on the vehicle;
transferring supplementary electrical power from a power source included in the vehicle to the vehicle-trailer interface via a second power line;
receiving trailer sway data at the ECU from a plurality of trailer sway detectors mounted on the vehicle, wherein the trailer sway data is received at the ECU via a vehicle communications bus;
generating brake control data based on the trailer sway data, wherein the brake control data includes two or more control signals for each of two or more braking devices mounted on the trailer, wherein each of the two or more control signals indicates to the braking devices a braking level that is to be applied by the braking device, and wherein the vehicle-trailer interface is configured to provide the supplementary electrical power to each of the two or more braking devices on the trailer; and
sending the brake control data from the modem to the vehicle-trailer interface via the power line at the same time the electrical power is transferring between the modem and the vehicle-trailer interface.
